(19) United States
(12) Patent Application Publication
(10) Pub. No.: US 2019/0147419 A1
(43) Pub. Date: May 16, 2019

(54) Vehicular Finance Compliance System and Method for Use of Same

(71) Applicant: Kenneth H. Terkel, League City, TX (US)

(72) Inventor: Kenneth H. Terkel, League City, TX (US)

(21) Appl. No.: 16/188,811

(22) Filed: Nov. 13, 2018

Related U.S. Application Data
(60) Provisional application No. 62/584,357, filed on Nov. 10, 2017.

(51) Int. Cl. G06Q 20/10; G06Q 20/14; B60R 25/04; G07C 5/00; G08G 1/00

(52) U.S. Cl. CPC G06Q 20/102; G06Q 20/14; G08G 1/205; G07C 5/008; B60R 25/04

(57) ABSTRACT

A system for vehicular finance compliance and method for use of the same are disclosed. In one embodiment of the system, onboard vehicle disabling devices are respectively located in vehicles under finance by a vehicle lending institution. A server is located in communication with the onboard vehicle disabling devices, a vehicle financing database, and a vehicle identification number database. The server receives information regarding payments made by a vehicle purchaser relative to a vehicle of interest. The server also receives information relative to the location of the vehicle. The server verifies the consistency between vehicle finance information in the vehicle financing database and the vehicle identification information in the vehicle identification information database prior to causing an interaction, such as disabling, enabling, providing an audiovisual notification or providing a payment code, with the vehicle of interest by transmitting a signal to the onboard vehicle disabling device of the vehicle.

### PRIORITY STATEMENT & CROSS-REFERENCE TO RELATED APPLICATIONS

This application claims priority from co-pending U.S. Patent Application No. 62/584,357 entitled “Vehicular Finance Compliance System and Method for Use of Same” filed on Nov. 10, 2017, in the name of Kenneth H. Terkel; which is hereby incorporated by reference for all purposes.

### TECHNICAL FIELD OF THE INVENTION

This invention relates, in general, to auto fleets and commercial vehicles and, in particular, to vehicular finance compliance systems and methods for use of the same which utilize Global Positioning System (GPS) technology to locate and remotely disable a vehicle in response to a missed payment or other event.

### BACKGROUND OF THE INVENTION

Vehicle lending institutions and finance companies may declare a loan in default and subject to applicable laws or repossess a vehicle from a borrower in response to a default such as a missed payment, for example. Responsible vehicle lending institutions and finance companies want to protect consumers, such as borrowers, from unfair, deceptive, and abusive practices and take action to repossess a vehicle from a borrower only when warranted following a default. Essential to protecting borrowers in the event of a repossession following a default is ensuring proper identification of the vehicle. This is particularly true if GPS technology will be employed to locate and remotely disable the vehicle. Necessary verification steps and safe guards need to be implemented to ensure the correct vehicle, often from a large database of vehicles being financed by the vehicle lending institution, is located and/or remotely disabled, for example. As a result of limitations in existing technology, there is a need for improved systems and methods of providing compliance to ensure the verification of the identification of a vehicle during a remote disabling of the vehicle.

### SUMMARY OF THE INVENTION

It would be advantageous for vehicle lending institutions and finance companies to achieve protection for consumers, such as borrowers, from unfair, deceptive, and abusive practices. It would also be desirable to enable a computer-based solution that would enable compliance to ensure the verification of the identification of a vehicle during a remote disabling of the vehicle. To better address one or more of these concerns, a vehicular finance compliance system and method for use of the same are disclosed. In one embodiment of the system, onboard vehicle disabling devices are respectively located in vehicles under finance by a vehicle lending institution. A server communicates with the onboard vehicle disabling device, a vehicle financing database, and a vehicle identification number database. The server receives information regarding payments made by a vehicle purchaser relative to a vehicle of interest. The server also receives information relative to the location of the vehicle. The server verifies the consistency between vehicle finance information in the vehicle financing database and the vehicle identification information in the vehicle identification information database prior to interacting with the vehicle of interest by transmitting a signal to the onboard vehicle disabling device of the vehicle of interest. The interaction may include disabling the vehicle of interest, providing an audiovisual notification, providing a payment code, or enabling the vehicle of interest. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram depicting one embodiment of a system for providing vehicular finance compliance according to the teachings presented herein;

FIG. 2 is a functional block diagram depicting one embodiment of an onboard vehicle disabling device which may be employed as part of the system shown in FIG. 1;

FIG. 3 is a functional block diagram depicting one embodiment of a server which may be employed as part of the system shown in FIG. 1;

FIG. 4 is a conceptual module diagram depicting a software architecture of a compliance application of some embodiments; and

FIG. 5 is a flow chart depicting one embodiment of a method for providing vehicular finance compliance according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

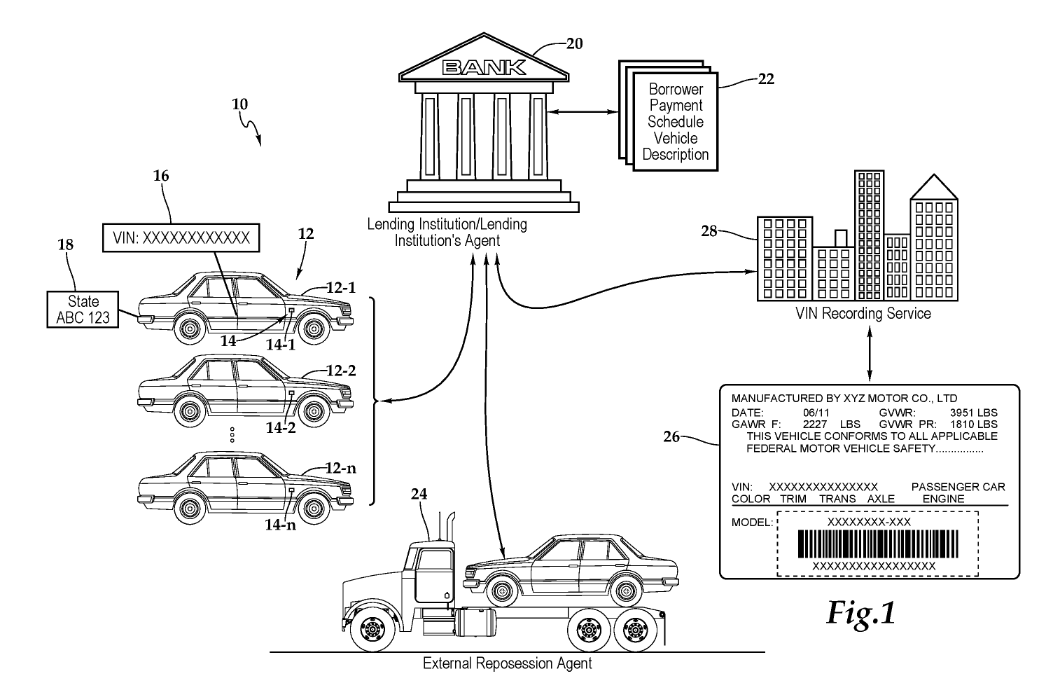

Referring initially to FIG. 1, therein is depicted one embodiment of a system 10 for providing vehicular finance compliance according to the teachings presented herein. The system 10 may be applicable to an automobile fleet under financing or commercial vehicles under financing, for example. As illustrated, vehicles 12 include individual vehicles 12-1 through 12-n each equipped with onboard vehicle disabling devices 14, which are respectively labeled onboard vehicle disabling device 14-1 through 14-n. With respect to the vehicle 12-1 as an example, each vehicle includes a vehicle identification number or VIN 16 and a license plate number 18. A vehicle lending institution or finance company or associated agent 20 monitors the financing of the vehicles 12 and ensures payments are timely made. Vehicle finance information 22 relative to the vehicles 12 is maintained and may include information about the borrower and payment schedule as well as information about the vehicle such as vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, vehicle airbag and safety information, for example, as well as license plate information, vehicle registration information, and vehicle ownership information, for example.

If payments are not made, then the vehicle lending institution or finance company or associated agent 20 may employ the services of an external repossession agent 24 to repossess the vehicle. As part of the repossession, the vehicle of interest is located by the onboard vehicle disabling device 14, which includes a GPS unit, as will be discussed in further detail. Additionally, the onboard vehicle disabling device 14 may be utilized to cause an interaction with the vehicle of interest such as disabling/enabling the vehicle of interest, providing an audiovisual notification, and/or providing a payment code, for example. Any audiovisual notification provided may be an audio signal, a visual signal, an audiovisual signal, or a combination thereof. By way of further example, in one embodiment, the audiovisual notification may be a “beep” or other sound or voice that notifies the driver of the vehicle of interest that a payment is due or past due. By way of another example, the vehicle of interest may be enabled for operation from payment-to-payment by a payment confirmation code that is provided to the user upon making a payment. If the payment code and payment confirmation code match, the vehicle of interest is enabled.

To confirm that the intended vehicle is receiving the interaction, the vehicle lending institution or finance company or associated agent 20 verifies the consistency between vehicle finance information 22 and vehicle identification information 26 made available by a VIN recording service 28, such as a VIN decoder, prior to disabling the vehicle of interest by transmitting a signal to the onboard vehicle disabling device 14 of the vehicle of interest. The vehicle identification information 26 may include vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information, for example, as well as license plate information, vehicle registration information, and vehicle ownership information, for example. The vehicle identification information 26 is accessible via the vehicle identification number or VIN 16 associated with the vehicle finance information 22. The vehicle identification number or VIN 16 may be a unique code, including a serial number, used by the automotive industry to identify individual motor vehicles. Further, the vehicle identification number or VIN 16 may be a unique code as defined in ISO 3779:2009. The vehicle identification number database, which stores the vehicle identification information 26 may be a database independently populated and maintained from the vehicle financing database, which stores the vehicle finance information 22.

Referring to FIG. 2, in one embodiment of the onboard vehicle disabling device 14 as a computing device includes a processor 40, memory 42, storage 44, inputs 46, and outputs 48 interconnected by a bus architecture 50 within a mounting architecture. The processor 40 may process instructions for execution within the computing device, including instructions stored in the memory 42 or in storage 44. The memory 42 stores information within the computing device. In one implementation, the memory 42 is a volatile memory unit or units. In another implementation, the memory 42 is a non-volatile memory unit or units. Storage 44 provides capacity that is capable of providing mass storage for the onboard vehicle disabling device 14. Various inputs 46 and outputs 48 may provide connections to and from the computing device, wherein the inputs 46 are the signals or data received by the onboard vehicle disabling device 14, and the outputs 48 are the signals or data sent from the onboard vehicle disabling device 14.

A transceiver 52 is associated with the onboard vehicle disabling device 14 and communicatively disposed with the bus 50. The transceiver 52 may be a transmitter/receiver, receiver, or an antenna for example. Communication between the onboard vehicle disabling device 14 and the vehicle lending institution or finance company or associated agent 20 or a server, for example, may be enabled by a variety of wireless methodologies employed by the transceiver 52. A vehicle disable output unit 54 is associated with the onboard vehicle disabling device 14 and communicatively disposed with the bus 50. In one embodiment, the vehicle disable output unit 54 is communicatively coupled to vehicle starter circuitry to send a command signal to enable and disable the vehicle. A GPS unit 56 is associated with the onboard vehicle disabling device 14 and communicatively disposed with the bus 50. The GPS unit 56 interfaces with a global navigation satellite system that provides geolocation and time information to the GPS unit 56.

The memory 42 and storage 44 are accessible to the processor 40 and include processor-executable instructions that, when executed, cause the processor 40 to execute a series of operations. The processor-executable instructions cause the processor 40 to send GPS location information via the transceiver 52 to the vehicle lending institution or finance company or associated agent 20 or a server, for example. The processor-executable instructions also cause the processor 40 to send a disable command to the vehicle starter circuitry upon receiving such instructions via the transceiver 52. The processor-executable instructions also cause the processor 40 to send an enable command to the vehicle starter circuitry upon receiving such instructions via the transceiver 52. In another embodiment, the processor-executable instructions may cause the processor 40 to send an enable command to the vehicle starter circuitry upon receiving a payment code via the transceiver 52. In still another embodiment, the processor-executable instructions may cause the processor 40 to enable an audiovisual notification, which may be an audio notification (such as a beep), visual notification, an audiovisual notification or a combination thereof. The onboard vehicle disabling device 14 may be in periodic or continuous communication with the vehicle lending institution or finance company or associated agent 20 or a server, or communication therewith in response to a request establish communication.

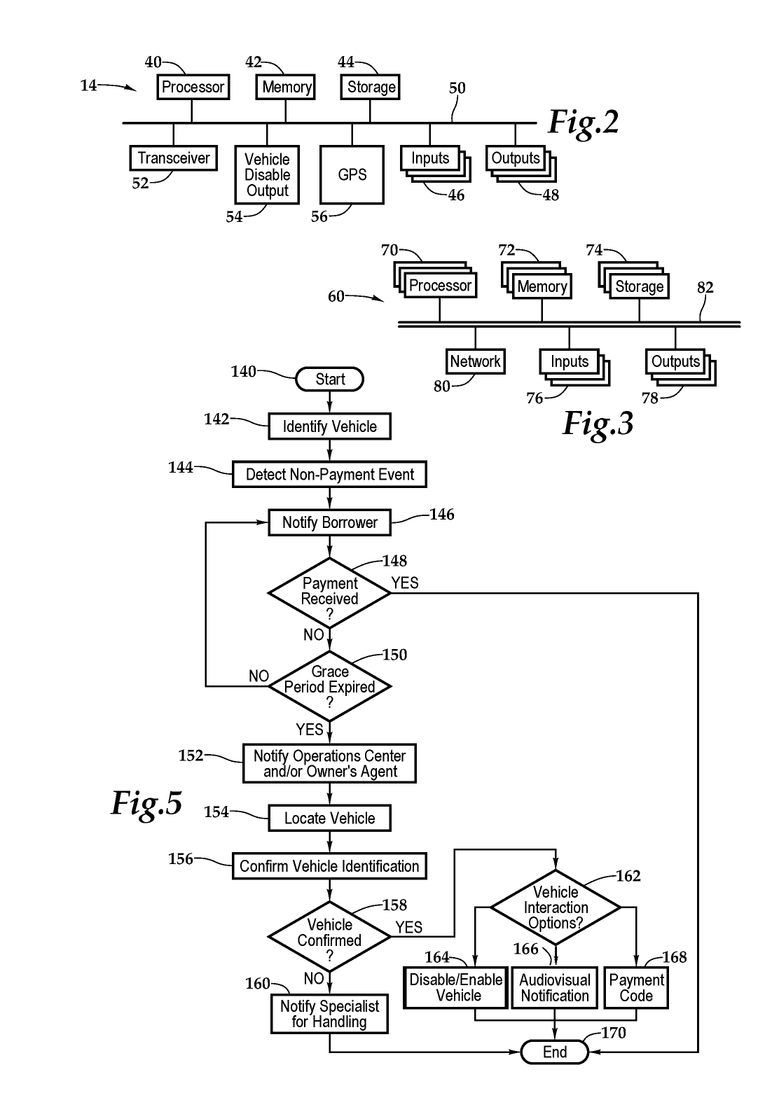

Referring now to FIG. 3, one embodiment of a server 60 as a computing device includes a processor 70, memory 72, storage 74, inputs 76, outputs 78, and a network adaptor 80 interconnected with various buses 82 in a common or distributed, for example, mounting architecture. The server 60 may form a portion of the lending institution or lending institution's agent or other entity involved in the financing of auto fleet or commercial vehicles, for example. In other implementations, in the computing device, multiple processors and/or multiple buses may be used, as appropriate, along with multiple memories and types of memory. Further still, in other implementations, multiple computing devices may be provided and operations distributed therebetween. The processor 70 may process instructions for execution within the server 60, including instructions stored in the memory 72 or in storage 74. The memory 72 stores information within the computing device. In one implementation, the memory 72 is a volatile memory unit or units. In another implementation, the memory 72 is a non-volatile memory unit or units. Storage 74 includes capacity that is capable of providing mass storage for the server 60. Various inputs 76 and outputs 78 provide connections to and from the server 60, wherein the inputs 76 are the signals or data received by the server 60, and the outputs 78 are the signals or data sent from the server 60. The network adaptor 80 couples the server 60 to a network such that the server 60 may be part of a network of computers, a local area network (LAN), a wide area network (WAN), an intranet, a network of networks, or the Internet, for example. Further, the network adaptor 80 may include connectivity to a transceiver to enable wireless communication with the onboard vehicle disabling device 14.

The memory 72 and storage 74 are accessible to the processor 70 and include processor-executable instructions that, when executed, cause the processor 70 to execute a series of operations. In one embodiment, the processor-executable instructions cause the processor 70 to receive information regarding payments made by a vehicle purchaser relative to a vehicle of interest belonging to the plurality of vehicles. Additionally, the processor-executable instructions cause the processor 70 to receive global positioning system information indicating the location of the vehicle of interest from the onboard vehicle disabling device 14 of the vehicle of interest. The processor 70 may then be caused to access the vehicle finance information 22 in the vehicle financing database relative to the vehicle of interest and access the vehicle identification information 26 in the vehicle identification number database relative to the vehicle of interest based on the vehicle identification number or VIN 16 in the vehicle finance information 22. The processor-executable instructions may then cause the processor 70 to verify consistency between the vehicle finance information 22 and the vehicle identification information 26, and upon verification of consistency between the vehicle finance information 22 and the vehicle identification information 26, transmit a signal to the onboard vehicle disabling device 14 of the vehicle of interest to cause an interaction with the vehicle of interest. The interaction may be disabling the vehicle of interest, enabling the vehicle of interest, providing an audiovisual notification, providing a payment code, or enabling the vehicle of interest, for example.

In one implementation, the memory 70 may further include processor-executable instructions that, when executed, cause the processor 70 to notify at least one external agent, such as a repossession agent, a credit issuer, a credit reporting agency, a lender, or a roadside assistance provider, for example. Notification to the vehicle purchaser or borrower of the information regarding payments may also be included as well as the notification to a specialist upon non-verification of consistency between the vehicle finance information 22 and the vehicle identification information 26.

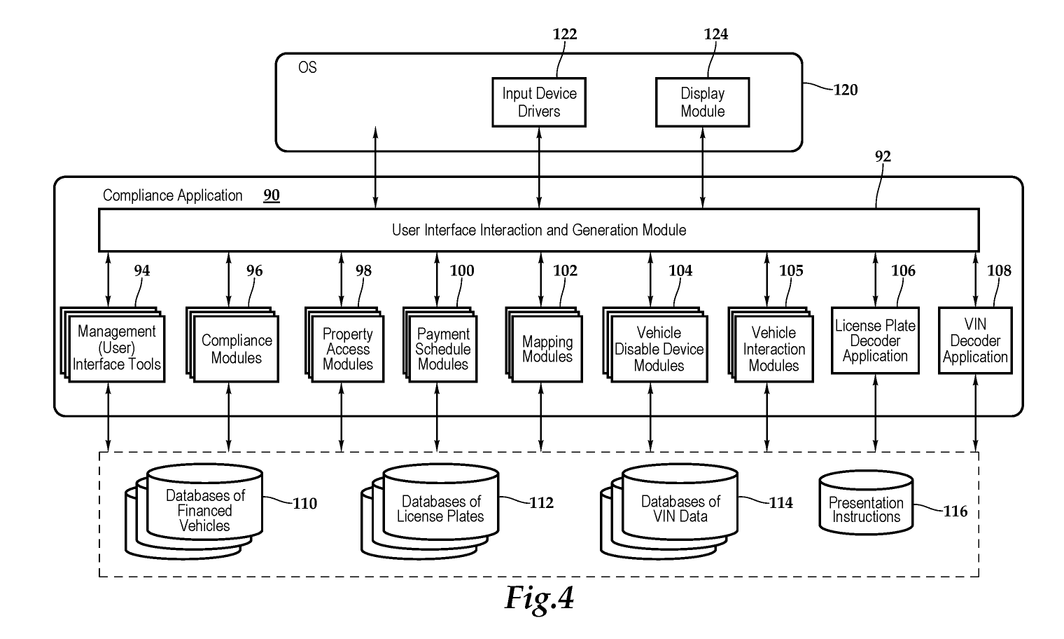

FIG. 4 conceptually illustrates the software architecture of a compliance application 90 of some embodiments that may utilized to ensure the verification of the identification of a vehicle during a remote disabling of the vehicle. In some embodiments, the compliance application 90 is a stand-alone application or is integrated into another application, while in other embodiments the compliance application 90 might be implemented within an operating system 120. Furthermore, in some embodiments, the compliance application 90 is provided as part of a server-based solution or a cloud-based solution. In some such embodiments, the application is provided via a thin client. That is, the application runs on a server while a user interacts with the application via a separate machine remote from the server. In other such embodiments, the application is provided via a thick client. That is, the application is distributed from the server to the client machine and runs on the client machine.

The compliance application 90 includes a user interface interaction and generation module 92, management (user) interface tools 94, compliance modules 96, property access modules 98, payment schedule modules 100, mapping modules 102, vehicle disable device modules 104, vehicle interaction modules 105, a license plate decoder application 106, and a VIN decoder application 108. The vehicle disable device modules 104 include, in one embodiment, the application software necessary for interacting with various onboard vehicle disabling devices, including handling enabling and disabling command signals, for example. The vehicle interaction modules 105 include the necessary application software to, in one embodiment, cause an interaction with the vehicle of interest such as providing an audiovisual notification, and/or providing a payment code, for example. The vehicle disable device modules 104 and the vehicle interaction modules 105 may be at least partially integrated. The property access modules 98 have access to the databases of financed vehicles 110. The databases of financed vehicles 110 may include the vehicle financing database storing the vehicle finance information 22. The license plate decoder application 106 has access to the databases of license plates 112, which may be accessed via a license plate decoder service, for example. The databases of license plates 112 may store the vehicle identification information 26 and be searchable by license plate 18. The VIN decoder application 108 has access to the databases of VIN data 114, which may be accessed via a VIN decoder service, for example. The databases of VIN data 114 may include the vehicle identification number database storing vehicle identification information 26 searchable by the vehicle identification number or VIN 16. The presentation instructions 116 may be accessed by the management (user) interface tools 94. Any of the databases 110, 112, 114, 116 may be partially or fully integrated with the server 60.

The management (user) interface tools 94 access operational instructions at the presentation instructions 116 for controlling the function of the various modules and applications within the compliance application 90. The compliance modules 96 use the property access modules 98, payment schedule modules 100, mapping modules 102, vehicle disable device modules 104, vehicle interaction modules 105, license plate decoder application 106, and the VIN decoder application 108 to locate and disable a vehicle of interest, which is financed, following a default event and after verification of the identification of the vehicle of interest using the databases of license plates 112 and databases of VIN data 114.

In the illustrated embodiment, FIG. 4 also includes an operating system 120 that includes input device driver(s) 122 and a display module 124. In some embodiments, as illustrated, the device drivers 122 and display module 124 are part of the operating system 120 even when the compliance application 90 is an application separate from the operating system 120. The input device drivers 122 may include drivers for translating signals from a keyboard, mouse, touchpad, tablet, touch screen, gyroscope, accelerometer, etc. A user interacts with one or more of these input devices, which send signals to their corresponding device driver. The device driver then translates the signals into user input data that is provided to the user interface interaction and generation module 92.

The present application describes a user interface that provides users with numerous ways to perform different sets of operations and functionalities to verify the identification of a vehicle of interest, which may be disabled, enabled, provided an audiovisual notification, and/or provided a payment code, for example. By either executing a pre-determined series of compliance instructions on a pre-determined set of data source files or receiving a selection of data processing operations, the present compliance application 90 achieves protection for consumers, such as borrowers, from unfair, deceptive, and abusive practices, when a vehicle may be disabled.

Referring now to FIG. 5, one embodiment of a method for vehicular finance compliance for auto fleets and commercial vehicles utilizing Global Positioning System (GPS) technology to locate and remotely disable a vehicle of interest in response to a missed payment or other event. The methodology starts at block 140 and progresses to block 142 where the vehicle of interest is identified. At block 144, a non-payment event is detected. At block 146, the borrower or vehicle owner is identified. At decision block 148, if payment has been received, then the methodology concludes at block 170. Otherwise, the methodology advances to decision block 150, where, in one embodiment, if the grace period to make the payment has not expired the methodology returns to block 146. On the other hand, if the grace period to make the payment has expired, then the methodology advances to block 152 where an operations center or other entity associated with the lender is notified. At block 154, utilizing the GPS associated with the onboard vehicle disabling device 14 installed in the vehicle of interest, the vehicle of interest is located. At block 156, confirmation of the vehicle identification is performed by comparing vehicle finance information 22 having the vehicle identification number or VIN 16 with vehicle identification information 26 available from a vehicle identification number decoder service. At decision block 158, if the confirmation does not provide verification, then the methodology advances to block 160 where a specialist is notified for further investigation and resolution into the matter before the methodology ends at block 170. If, however, the confirmation provides verification, then the methodology advances to decision block 162 where multiple vehicle interaction options are presented. By way of example, at block 164 the vehicle of interest may be remotely disabled or enabled prior to ending the methodology at block 170. Returning to decision block 162, an audiovisual notification may be provided to the vehicle of interest at block 166 prior to ending the methodology at block 170. With respect to a third option, a payment code may be provided to the vehicle of interest at block 168 prior to ending the methodology at block 170.

The order of execution or performance of the methods and process flows illustrated and described herein is not essential, unless otherwise specified. That is, elements of the methods and process flows may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for vehicular finance compliance, the system comprising:
a plurality of onboard vehicle disabling devices located in a respective plurality of vehicles under finance by a vehicle lending institution, each of the respective plurality of vehicles having a vehicle identification number;
a vehicle financing database storing vehicle finance information relative to the plurality of vehicles under finance by the vehicle lending institution, the vehicle finance information including the vehicle identification number;
a vehicle identification number database storing vehicle identification information searchable by the vehicle identification number;
a server located in communication with the plurality of onboard vehicle disabling devices, the vehicle financing database, and the vehicle identification number database, the server including a processor and memory communicatively interconnected with a busing architecture; and
the memory accessible to the processor, the memory including processor-executable instructions that, when executed, cause the processor to:
receive information regarding payments made by a vehicle purchaser relative to a vehicle of interest belonging to the plurality of vehicles,
receive global positioning system (GPS) information indicating the location of the vehicle of interest from the onboard vehicle disabling device of the vehicle of interest,
access the vehicle finance information in the vehicle financing database relative to the vehicle of interest,
access the vehicle identification information in the vehicle identification number database relative to the vehicle of interest based on the vehicle identification number in the vehicle finance information,
verify consistency between the vehicle finance information and the vehicle identification information, and
upon verification of consistency between the vehicle finance information and the vehicle identification information, transmit a signal to the onboard vehicle disabling device of the vehicle of interest to cause an interaction with the vehicle of interest.

2. The system as recited in claim 1, wherein the vehicle finance information further comprises information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information.

3. The system as recited in claim 1, wherein the vehicle finance information further comprises information selected from the group consisting of license plate information, vehicle registration information, and vehicle ownership information.

4. The system as recited in claim 1, wherein the vehicle identification information further comprises information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information.

5. The system as recited in claim 1, wherein the vehicle identification information further comprises information selected from the group consisting of license plate information, vehicle registration information, and vehicle ownership information.

6. The system as recited in claim 1, wherein the vehicle identification number further comprises a unique code, including a serial number, used by the automotive industry to identify individual motor vehicles.

7. The system as recited in claim 1, wherein the vehicle identification number further comprises a unique code as defined in ISO 3779:2009.

8. The system as recited in claim 1, wherein the vehicle identification number database further comprises a database independently populated and maintained from the vehicle financing database.

9. The system as recited in claim 1, wherein the vehicle identification number database further comprises a vehicle identification number decoder database.

10. The system as recited in claim 1, wherein the memory further comprises processor-executable instructions that, when executed, cause the processor to notify at least one external agent selected from the group consisting of a repossession agent, a credit issuer, a credit reporting agency, a lender, and a roadside assistance provider.

11. The system as recited in claim 1, wherein the memory further comprises processor-executable instructions that, when executed, cause the processor to notify the vehicle purchaser of the information regarding payments.

12. The system as recited in claim 1, wherein the memory further comprises processor-executable instructions that, when executed, cause the processor to notify a specialist upon non-verification of consistency between the vehicle finance information and the vehicle identification information.

13. The system as recited in claim 1, wherein the interaction with the vehicle of interest further comprises disabling the vehicle of interest.

14. The system as recited in claim 1, wherein the interaction with the vehicle of interest further comprises providing an audiovisual notification to the vehicle of interest.

15. The system as recited in claim 1, wherein the interaction with the vehicle of interest further comprises providing a payment code to the vehicle of interest.

16. The system as recited in claim 1, wherein the server further comprises a cloud-based deployment.

17. The system as recited in claim 1, wherein the server and the vehicle financing database are at least partially integrated.

18. The system as recited in claim 1, wherein the server and the vehicle identification number database are at least partially integrated.

19. A system for vehicular finance compliance, the system comprising:
a plurality of onboard vehicle disabling devices located in a respective plurality of vehicles under finance by a vehicle lending institution, each of the respective plurality of vehicles having a vehicle identification number;
a vehicle financing database storing vehicle finance information relative to the plurality of vehicles under finance by the vehicle lending institution, the vehicle finance information including the vehicle identification number;
the vehicle finance information includes information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information;
a vehicle identification number database storing vehicle identification information searchable by the vehicle identification number;
the vehicle identification information includes information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information;
a server located in communication with the plurality of onboard vehicle disabling devices, the vehicle financing database, and the vehicle identification number database, the server including a processor and memory communicatively interconnected with a busing architecture; and
the memory accessible to the processor, the memory including processor-executable instructions that, when executed, cause the processor to:
receive information regarding payments made by a vehicle purchaser relative to a vehicle of interest belonging to the plurality of vehicles,
receive global positioning system (GPS) information indicating the location of the vehicle of interest from the onboard vehicle disabling device of the vehicle of interest,
access the vehicle finance information in the vehicle financing database relative to the vehicle of interest,
access the vehicle identification information in the vehicle identification number database relative to the vehicle of interest based on the vehicle identification number in the vehicle finance information,
verify consistency between the vehicle finance information and the vehicle identification information, and
upon verification of consistency between the vehicle finance information and the vehicle identification information, transmit a signal to the onboard vehicle disabling device of the vehicle of interest to cause an interaction with the vehicle of interest, the interaction being selected from the group consisting of disabling the vehicle of interest, enabling the vehicle of interest, providing an audiovisual notification, and providing a payment code.

20. A system for vehicular finance compliance, the system comprising:
a plurality of onboard vehicle disabling devices located in a respective plurality of vehicles under finance by a vehicle lending institution, each of the respective plurality of vehicles having a vehicle identification number;
the vehicle identification number includes a unique code, including a serial number, used by the automotive industry to identify individual motor vehicles;
a vehicle financing database storing vehicle finance information relative to the plurality of vehicles under finance by the vehicle lending institution, the vehicle finance information including the vehicle identification number;
the vehicle finance information includes information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information;
a vehicle identification number database storing vehicle identification information searchable by the vehicle identification number;
the vehicle identification information includes information selected from the group consisting of vehicle year, vehicle make, vehicle model, vehicle engine, vehicle body type, vehicle interior options, vehicle exterior options, vehicle fuel type, vehicle suspension information, vehicle braking information, vehicle electronics options, vehicle power options, and vehicle airbag and safety information;
a server located in a cloud-based deployment in communication with the plurality of onboard vehicle disabling devices, the vehicle financing database, and the vehicle identification number database, the server including a processor and memory communicatively interconnected with a busing architecture; and
the memory accessible to the processor, the memory including processor-executable instructions that, when executed, cause the processor to:
receive information regarding payments made by a vehicle purchaser relative to a vehicle of interest belonging to the plurality of vehicles,
receive global positioning system (GPS) information indicating the location of the vehicle of interest from the onboard vehicle disabling device of the vehicle of interest,
access the vehicle finance information in the vehicle financing database relative to the vehicle of interest,
access the vehicle identification information in the vehicle identification number database relative to the vehicle of interest based on the vehicle identification number in the vehicle finance information,
verify consistency between the vehicle finance information and the vehicle identification information, and
upon verification of consistency between the vehicle finance information and the vehicle identification information, transmit a signal to the onboard vehicle disabling device of the vehicle of interest to cause an interaction with the vehicle of interest, the interaction being selected from the group consisting of disabling the vehicle of interest, enabling the vehicle of interest, providing an audiovisual notification, and providing a payment code.
